(19) United States
(12) Patent Application Publication
(10) Pub. No.: US 2018/0045184 A1
(43) Pub. Date: Feb. 15, 2018

(54) Ionic Capacitive Laminate and Method of Production

(71) Applicant: University of Tartu, Tartu (EE)

(72) Inventors: Indrek MUST, Tartu (EE); Urmas JOHANSON, Tartu (EE); Inna BARANOVA, Tartu (EE); Friedrich KAASIK, Tartu (EE); Alvo AABLOO, Tartu (EE)

(21) Appl. No.: 15/557,034

(22) PCT Filed: Mar. 8, 2016
(86) PCT No.: PCT/IB2016/051304

§ 371 Date: Sep. 8, 2017

(30) Foreign Application Priority Data
Mar. 8, 2015 (GB) 1503900.1

(51) Int. Cl. F03G 7/00

(52) U.S. Cl. CPC F03G 7/005; B32B 5/02

(57) ABSTRACT

The application relates to flexible ionic electroactive polymer (IEAP) laminates also known as ionic capacitive laminates (ICLs) particularly used for actuators, sensors or capacitors. More specifically, the invention relates to ICLs capable of fabrication on an industrial scale. An ionic electroactive polymer laminate suitable for use as an actuator is described, comprising opposing planar electrodes separated by an electrode-separating layer, wherein the electrode separating layer comprises a flexible porous reinforcing web suitable for supporting the laminate during fabrication, the electrode-separating layer further including an ion permeable polymer membrane within the pores of the reinforcing web. A method of producing an ionic electroactive polymer laminate suitable for use as an actuator is also described, comprising the steps of producing a planar electrode-separator by supporting a flexible, porous reinforcing web so that it is taught, impregnating the reinforcing web with a membrane solution that includes a polymer suitable for forming an ion permeable membrane, a pore-forming liquid and a solvent, evaporating the solvent to form an ion permeable membrane within the structure of the reinforcing web, the method further including the steps of coating each side of the planar electrode-separator with an electrode solution comprising material suitable for forming electrodes and an electrode solvent, evaporating the electrode solvent to form planar electrodes separated by the electrode-separator.

### BACKGROUND

### Field of the Invention

The invention relates to flexible ionic electroactive polymer (IEAP) laminates also known as ionic capacitive laminates (ICLs) particularly used for actuators, sensors or capacitors. More specifically, the invention relates to ICLs capable of fabrication on an industrial scale.

### Description of Related Art

Electroactive polymers (EAPs) are polymers that exhibit a change in size or shape when stimulated by an electric field. The most common applications of this type of material are in actuators and sensors. A typical characteristic property of an EAP is that they will undergo a large amount of deformation while sustaining large forces. EAPs have applications in devices and systems involving smart materials inherently capable of changing dimensions and/or shape in response to suitable electrical stimuli, so as to transduce electrical energy into mechanical work. They can also operate in reverse mode, transducing mechanical energy into electrical energy or can be used to store energy. Therefore, they can be used as actuators, electromechanical sensors, as well as energy harvesters to generate electricity and capacitors to store electricity. For such tasks, EAPs show unique properties, such as sizable electrically driven active strains or stresses, high mechanical flexibility, low density, structural simplicity, ease of processing and scalability, no acoustic noise and low costs.

EAPs used in actuator mode are referred to as ‘artificial muscles’ because they have muscle-like structural or functional properties or can be functional or physical substitutes or supports for natural muscles. Artificial muscles can be used for robotics, automation, medicine, biomimetics, haptics, biotechnology, fluidics, optics and acoustics, light-weight drive mechanisms, intrinsically safe robots, anthropomorphic robots and humanoids, bioinspired and biomimetic systems, robotic hands/arms/legs/wings/fins, locomotion systems, grippers, manipulators, haptic devices, variable-stiffness devices and linkages, active vibration dampers, minimally-invasive interventional/diagnostic medical tools, mechanical stimulators for cells and tissues, controlled drug delivery devices, fluidic valves and pumps, tunable optical and acoustic systems, energy harvesting, prosthetics, orthotics, and artificial organs, artificial skeletal, smooth, and cardiac muscles, artificial hearts and blood vessels, ventricular assist devices, artificial bladders and sphincters, prosthetic hands/arms/legs and articular joints, powered orthoses, exoskeletons and augmenting systems, and wearable systems for motor rehabilitation and personal assistance.

The emerging field of soft biomimetic robotics in particular is in demand of novel structural, actuating, sensory, and energy storage materials that can be manufactured on an industrial scale at low cost. Soft laminates that change their size and shape by rearrangement of the mobile ions within a microporous structure as a result of an applied electric field are particularly perspective for soft robotic applications. This class of materials are referred to as ionic EAPs (IEAPs) also known as ionic and capacitive laminates (ICLs), where the porous polymeric membrane is capable of transporting cations and anions, but not electrons, across its structure.

Actuation of ICLs is caused by the displacement of ions within the composite material. Only a few volts are needed for actuation, but the ionic flow implies a higher electrical power needed for actuation. Energy is not consumed to keep the actuator at a given position. Examples of ICLs are ICLs with conductive polymer electrodes, ionic polymer-metal composites (IPMCs), and responsive gels. Ionic polymer-metal composites (IPMCs) are synthetic composite nanomaterials composed of an ionic polymer like Nafion (registered trade mark) or Flemion (registered trade mark) whose surfaces are chemically plated or physically coated with high surface area electrodes and current collectors such as platinum or gold. Under an applied voltage (1-5 V), ion migration and redistribution due to the imposed voltage across a strip of IPMCs result in a bending deformation. If the plated electrodes are arranged in a non-symmetric configuration, the imposed voltage can induce twisting, rolling and non-symmetric bending deformation. Alternatively, if such deformations are physically applied to IPMC strips they generate an output voltage signal (few millivolts for typical small samples) as sensors and energy harvesters. They work very well in a liquid environment. IPMCs with water as a solvent have very limited performance in air. IPMCs with ionic liquid electrolyte are operable in air or in ionic liquid. They have a force density of about 40 in a cantilever configuration, meaning that they can generate a tip force of almost 40 times their own weight in a cantilever mode. IPMCs in actuation, sensing and energy harvesting have a very broad bandwidth to kilo Hz and higher. Known manufacturing methods for ionic polymer-metal composites (IPMCs) are only suitable for laboratory-scale production and involve chemical deposition of noble metals, e.g. platinum, palladium, or gold, on the surface of an ionic polymer (most frequently, Nafion) membrane. This process is reasonably repeatable, but the high cost of noble metals prohibits commercial application.

The ‘Bucky-gel’ actuator (BGA), was developed by Fukushima et al. in 2005. The term ‘BGA’ can refer to an actuator that incorporates one particular electrode material, ‘Bucky gel’, i.e. a gelatinous mixture of ionic liquid and carbon nanotubes. BGAs can be produced by a layer-by-layer assembly process where the electrode and separator layers are individually cast into a mould and subsequently fused together by hot-pressing. One limitation concerning the BGAs is their comparably high price: the best electrode conductivity and electromechanical response is achieved by the use of ‘Bucky gel’ with extremely long and conductive carbon nanotubes, but the currently available techniques for separation of carbon nanotubes of suitable grade have extremely low yield, which obviously result in their prohibitively high price for potential applications. Actuators similar to BGAs have been fabricated also using other types of porous carbons. Another major limitation of the BGAs is low repeatability of their manufacturing process. The hot-pressing phase, carried out during the manufacturing procedure, must be done in an extremely careful manner, as slightly improper pressure, temperature, or timing settings can result in either delamination or short-circuiting of the actuator. Short-circuiting of the BGA is a common cause of failure in its fabrication process, as the soft and thin polymeric membrane that is heated close to its melting point can be easily squeezed out under applied pressure from between the more rigid electrode layers, creating undesired electronic conduction pathways between the electrodes (i.e. the short-circuit ‘hotspots’). Today, the manufacturing process of the BGAs can produce small (up to several cm²) batches of BGAs in laboratory conditions, but the manufacturing process shows very limited scalability: an increase in the batch size causes progressively larger inhomogeneity between different areas within one batch and also between consecutive batches. The homogeneity is expressed as (a) homogeneous constitution of the polymer-bound carbon material throughout the whole electrode; (b) uniform electrical and electromechanical properties; (c) uniform thickness of the laminate; (d) uniform thickness ratio between the membrane and the electrode. Increasing the amount of the electrode material also increases the time of preparation, especially getting long carbon nanotubes into suspension. A more reproducible preparation process for BGAs is consequently desired.

A Direct assembly process' (DAP) for fabrication of ICL laminates was developed by Akle et al. in 2007. DAP involves spray-painting of multiple (typically 10-30) layers of electrode material suspension on the opposite sides of a microporous polymer membrane. Using DAP, ICLs can be prepared using a variety of electrode materials: transition metal oxides, activated carbon powder, metal nanoparticles, etc. Compared to the layer-by-layer assembly process, the ‘traditional’ DAP yields considerably larger (several tens of cm²) ICL batches, but the maximum batch size is still very limited.

After application of each consecutive electrode layer, the volatile solvents quickly diffuse from the newly applied layer into the previously applied electrode layers and the polymeric membrane. The volatile solvents need to be evaporated before application of the next layer. Extensive and anisotropic swelling of the freestanding laminate during its manufacturing process creases the laminate, resulting in inconsistent electrode coverage. To prevent the laminate from spontaneous curling, the laminate must be securely fixed from its sides. In addition, extensively swollen polymeric membrane softens and it can break even under its own weight when suspended. Consequently, the ‘conventional’ DAP is labour-intensive and time-consuming, and is practical for manufacturing only small batches of ICLs for research purposes. Consequently, there is a huge need for developing a method for preparing ICL actuators in a repeatable fashion and in large batches.

### SUMMARY OF THE INVENTION

In an embodiment, an ICL with an electrode-separator reinforced with a web is provided. The reinforcement can be a fabric core. The use of a fabric-based separator makes it possible to fabricate ICL actuators in a virtually unlimited industrial scale quantity. The improved DAP is demonstrated in a semi-laboratory-scale, however, this process is fully up-scalable to automated, industrial roll-to-roll conveyors for preparing ICLs at unprecedented repeatability, cost, and quantity.

In an embodiment, the ICL is formed layer-by-layer on the sides of a fibrous, woven or knitted substrate. The term “web” is used to define all types of flexible structural substrate, e.g. woven, fibrous (non-woven) or knitted. In principle, any type of inert textile or mesh-like substrate can be used as the substrate. Examples include those based on synthetic (artificial) fibers and/or yarns, chosen in particular from fibers and/or yarns of polyolefin such as polyethylene (PE) or polypropylene (PP), of polyester such as polyethylene terephthalate, of fluoropolymer such as polytetrafluoroethylene (PTFE) or polyvinylidene fluoride (PVDF), of polyamide or of polyimide; and/or based on mineral fibers such as glass fibers, and/or based on natural fibers and/or yarns, such as cotton or wool fibers and/or yarns.

The use of a fibrous substrate does not change the actuator's performance, but serves as a support during the ICL manufacturing process. However, the substrate fully retains its load-bearing capacity, which creates an excellent opportunity to create smart textiles with inherently integrated ICL actuators, sensors, and energy storage units.

In an embodiment, an ionic electroactive polymer (IEAP) laminate, also referred to as an ionic capacitive laminate (ICL) suitable for use as an actuator is provided, comprising opposing planar electrodes separated by an electrode-separating layer, wherein the electrode separating layer comprises a flexible porous reinforcing web suitable for supporting the laminate during fabrication, the electrode-separating layer further including an ion-permeable polymeric membrane within the free space of the reinforcing web. The membrane may encapsulate the reinforcing web. The electrodes may be a porous flexible material comprising a mixture of polymer and a conductive material. The conductive material may be carbon-based. The membrane and the electrodes may contain the same type of polymer. The membrane and electrodes may be supplied ‘inactive’ without an electrolyte, or be impregnated with an ionic liquid as an electrolyte. If it is supplied in an inactive state then the end user can soak the laminate in ionic liquid to activate it, the ionic liquid displacing the non-ionic liquid it is manufactured with. The reinforcing web may be a textile or non-woven material of any thickness but 10-100 microns thickness is preferable.

Each of the planar electrodes has an inner face in contact with the electrode-separator and an outer face, wherein a metallic current collecting foil may be provided in contact with the outer face of each of the electrodes.

In a further embodiment it is envisaged that an electrode-separator for use in the manufacture of an ionic electroactive polymer laminate is provided, comprising a flexible porous reinforcing web suitable for supporting the laminate during fabrication, the electrode-separating layer further including an ion exchange polymer membrane in the pores of the reinforcing web. The electrode separator may be manufactured and supplied ‘inactive’ i.e. without electrolyte, or supplied impregnated with an ionic liquid as an electrolyte.

There are a number of reasons for manufacturing the laminate in an inactive state, i.e. without an ionic liquid. First, it can be beneficial for developing more efficient process flows. For example, if the laminate is made in a form of large inactivated sheets, it is possible to later activate only some parts of the ICL. The boundaries of the active parts can be defined, for example, by filling the pores with an ion-impermeable compound, or by heat-sealing. Second, as ionic liquids are corrosive in their nature, it can be incompatible with some intermediary steps in making a product, for example, the sewing process in making products from smart textiles. Also, an ICL without the electrolyte is more rigid and possibly can endure higher compressive stresses during processing. Thirdly, it is difficult to completely remove ionic liquid from the system because of the properties of ionic liquids. Making an inactive sheet and then filling the pores is much simpler than removing ionic liquids from the areas that need to be inactivated for some reason. Fourthly, it can increase the number of available polymer materials that are suitable as membranes.

The ionic electroactive polymer laminate may be used as an actuator, as a sensor or as an energy storage device, i.e. a capacitor. The particular function of an ICL can be determined after manufacturing and the function can be interchanged on demand during employment.

In a further embodiment, a method of producing a free-standing ionic electroactive polymer laminate suitable for use as an actuator is provided, comprising the steps of producing a planar electrode-separator by supporting a flexible, porous reinforcing web so that it is taught, impregnating the reinforcing web with a membrane solution that includes a polymer suitable for forming an ion permeable membrane, a pore-forming liquid for forming pores in the polymer and a solvent, evaporating the solvent to form an ion permeable membrane within the structure of the reinforcing web, the method further including the steps of coating each side of the planar electrode-separator with an electrode solution comprising material suitable for forming electrodes and an electrode solvent, evaporating the electrode solvent to form planar electrodes separated by the electrode-separator.

The membrane solution and/or the electrode solution may be applied by spraying. Spray coating the membrane has the advantage that the ionic conductivity of the membrane is improved. The membrane solution and/or the electrode solution may also be applied by painting or dip coating. The cycle of applying the membrane solution and evaporating the solvent may be repeated to produce a membrane of a required thickness. The cycle of applying the electrode solution and evaporating the solvent may also be repeated to produce electrodes of a required thickness.

The membrane may be formed from a polymer and a non-ionic liquid or may be formed of an ionic gel comprising the polymer and an ionic liquid. The electrode material may be a mixture of a polymer (either an ionic or non-ionic polymer), an electrically conductive material and a pore forming liquid, where the pore-forming liquid may be a non-ionic liquid or may further include an ionic liquid. The membrane and electrode may be formed using a non-ionic liquid and this liquid later substituted for an ionic liquid. The conductor may be carbon based. The method may further include the steps of applying metallic foils to the outside of the electrodes as current conductors.

### BRIEF DESCRIPTION OF THE DRAWINGS

FIG. 1a is a schematic diagram showing an embodiment of the invention, where the structure of the ICL is revealed in cutaway.

FIG. 1b is a schematic diagram showing a cutaway view of an electrode-separator according to an embodiment of the invention with a thin membrane layer on the reinforcing web.

FIG. 1c is a diagram showing an embodiment of the ICL in operation as an actuator, where a voltage applied to the electrodes causes curving movement of the laminate structure from position A when no voltage is applied to position B when a voltage is applied.

FIG. 2a is a schematic diagram showing a cross section of an ICL according to an embodiment of the invention.

FIG. 2b is a micrograph of a cross section of an ICL according to an embodiment.

FIG. 3a is a schematic diagram showing a cross section of an ICL according to an embodiment of the invention at rest.

FIG. 3b is a schematic diagram showing a cross section of an ICL according to an embodiment of the invention with a voltage applied across the electrodes.

FIG. 3c is a schematic diagram showing a cross section of an ICL according to an embodiment of the invention with a voltage applied showing how the central reinforcing web flexes but does not expand or contract.

FIG. 4a is a graph showing the curvature response of an embodiment of the ICL as different charge is applied onto the ICL material.

FIG. 4b is a graph showing the curvature and current response of an embodiment of the ICL as a time varying voltage profile is applied to the electrodes of the ICL.

FIG. 5a shows how the reinforcing web is supported in a laboratory-scale fabrication process.

FIG. 5b shows how the laminate is dried in a laboratory-scale fabrication process.

FIG. 5c is a schematic diagram showing roll-to-roll processing and spray painting of electrodes or membranes.

FIG. 6a is a schematic diagram showing the spray coating of a membrane onto the reinforcing web to make an electrode-separator of an embodiment of the ICL.

FIG. 6b is a schematic diagram showing the spray coating of electrodes onto the electrode-separator of an embodiment of the ICL.

FIG. 7a is a schematic diagram showing how gold foil current collectors are applied to the outside of the electrodes in an embodiment of the invention.

FIG. 7b shows how the shape of an ICL is fixed having non-planar configurations.

FIG. 8 is a representation of an industrial process for implementing an embodiment of the invention.

### DETAILED DESCRIPTION OF THE PREFERRED EMBODIMENT

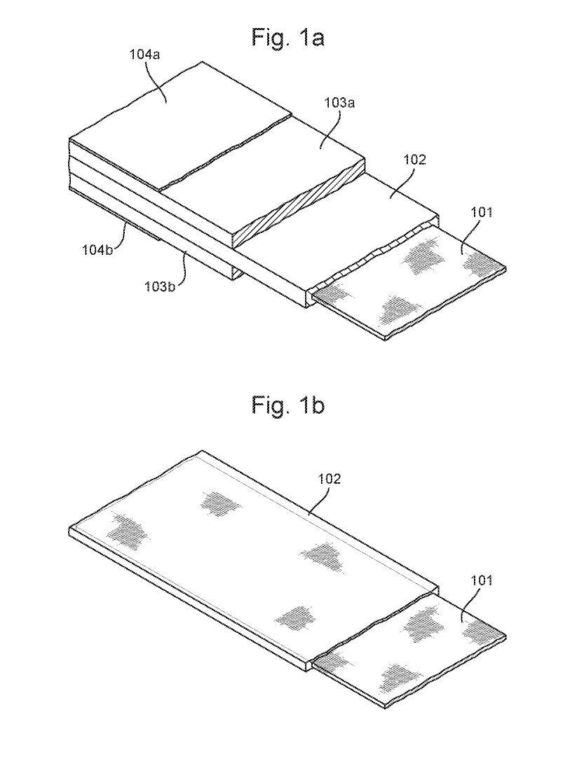

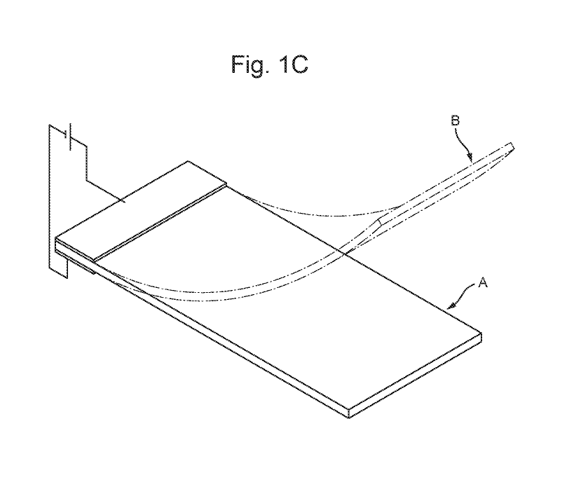

An embodiment of the invention is shown in FIG. 1a, where a strip of ICL material comprising a core of reinforcing web 101, a polymer membrane 102, electrodes 103a, 103b and current collectors 104a, 104b are shown.

The reinforcing web 101 is preferably an inert, thin, inelastic, and electrically nonconductive mesh. However, it could be made of any material that does not dissolve in the solvents used during the fabrication process. This reinforcement grid 101 forms the middlemost layer of the ICL. A glass fibre mesh of thickness 30 to 100 micrometres (microns) is suitable as the reinforcement grid 101. The reinforcing web 101 preferably has mechanical properties of strength and flexibility, therefore a woven fabric or textile having a weft and warp of single filaments or filament bundles is suitable. The proportions of the material used for the reinforcing web 101 are selected so that the web 101 is permeable to liquid but having mesh openings that allow liquid to bridge the gaps between threads of the web for reasons discussed in more detail below. A suitable mesh opening is 100 microns (μm).

The primary function of the reinforcement layer is to support the ICL laminate during its manufacturing process. It (a) enables manufacturing of batches with virtually unlimited size, (b) enables manufacturing of membrane layers by spray-painting, and (c) increases homogeneity within each batch and repeatability between subsequent batches.

The other function of the reinforcement layer is to define the position of the neutral layer within the ICL laminate while undergoing bending actuation.

Further, it also makes it possible to apply axial loads to the laminate, as the reinforcement grid prevents the ICL from stretching out and preserves its operating ability under applied tensile stress. It enables intrinsic incorporation of actuators, sensors, and energy storage units into various textiles that can perform other functions and can be a subcomponent of any system.

The structure of any fabric is such that porosity varies on different length scales, for example on the individual fibre scale, yarn scale (bundles of fibers) and woven structure scale. Woven fabrics exhibit free space between individual fibres (2-4 μm) and between yarns (10-100 μm). The free space between the yarns is referred to as the mesh opening. The reinforcing web 101 is impregnated with a polymeric membrane 102. The porosity of the fabric determines the extent of the polymeric membrane and therefore the ion mobility across the membrane. In this context, impregnated means that the membrane 102 is at least fully contained within the thickness of the web 101 and can fill the pore volume between fibres within the yarns and the mesh openings between the yarns of the web 101, to ensure that the electrodes 103 are not in physical contact and that there is an ion permeability between the electrodes 103. FIG. 1b shows a reinforcing web lightly coated with the membrane. It is possible to provide a thicker membrane by encapsulating the reinforcing web 101 in membrane material as shown in FIG. 1a.

Together, the web 101 and membrane 102 form an electrode-separating layer. It is preferable for the electrode-separating layer to be as thin as possible while maintaining structural strength and electronic insulation of the electrodes from each other. A thin electrode-separating layer improves ionic conductivity and therefore response time of the device.

The polymeric membrane 102 is a composite of a solid phase polymer permeated with an ionic liquid as an electrolyte. For the polymer, any polymer that forms a gel with an ionic liquid is suitable, such as KYNAR 2801, polyvinylidene difluoride (PVF), polyvinylidene difluoride-co-hexafluoropropylene (PVdF(HFP)), Nafion, Flemion or cellulose. The ionic liquid is selected from ionic liquids in which cations are various alkyl-substituted ammonium ions, alkyl-substituted pyrrolidonium ions, alkyl-substituted imidasolium ions, or alkyl-substituted piperidinium ions, and anions are trifluoromethanesulphonate ions, bis(trifluoromethanesulfonyl)imide ions, bis(fluorosulfonyl)imide ions, bis(pentafluoroethanesulfonyl)imide ions, tetrafluoroborate ions, ethyl sulfate ions, or hexafluorophosphate ions. For example 1-ethyl-3-methyl-imidasolium tetrafluoroborate (EMIBF4) or 1-ethyl-3-methyl-imidasolium trifluoromethanesulphonate (EMITFS) can be used. It is not necessary that the polymer is an ionic conductor. However, it is important that there is a porous network within the polymer. The porous structure is filled with the ionic liquid, allowing ions to be transported across the membrane structure between the electrodes when an electric field is applied to the electrodes. It is also possible that the membrane is initially formed from a mixture of a polymer and a non-ionic liquid to create the percolation network in the membrane. In this case the membrane can be functionalized at a later time by replacing the non-ionic liquid with an ionic liquid as an electrolyte.

The function of the polymeric membrane 102 is to allow the passage of ions and to provide an electronically insulating layer between the electrodes 103.

The principle requirements of the electrodes 103 is that they have a high surface area of electronically conductive material and can provide a reservoir for positive and negative ions and can expand and contract without damage to its structure; a porous conducting material in a polymer binder is ideal for this application. The electrodes 103 are formed on the electrode-separating layer and are composed of porous activated carbon. An example is carbide-derived carbon, such as highly homoporous carbide derived carbon. The carbon is mixed with a suitable polymer binder and ionic liquid. The polymer binder in the electrodes can be the same as that used for the membrane 102. The electrodes can also be initially formed using a non-ionic liquid that is later replaced by an ionic liquid. The electrode layer may contain porous polymer or carbon nanotubes or other additional carbonaceous materials. Carbide-derived carbon material (CDCs) are obtained from TiC at temperatures 400° C., 600° C., 800° C., 850° C., and 950° C. and which has a varied pore distribution in carbon material. Carbon films may also be prepared from B4C and Mo2C and from materials like carbon aerogels and from carbon synthesized by pyrolysis or hydrothermal carbonization of organic matter, or from carbon black. So as to aggregate carbon material in the electrode layer, poly(vinylidene difluoride-hexafluoropropylene) (PVdF(HFP)) can be used as a binder, and 1-ethyl-3-methyl-imidasolium trifluoromethanesulphonate (EMITFS) can be used as an ionic liquid.

Current collectors 104a, 104b are metal foils layered over each electrode 103a, 103b. They are not essential but reduce the surface resistance of the ICL from around 100 KΩ/cm to 1 Ω/cm. Suitable current collector materials include gold, platinum, aluminium, silver and titanium.

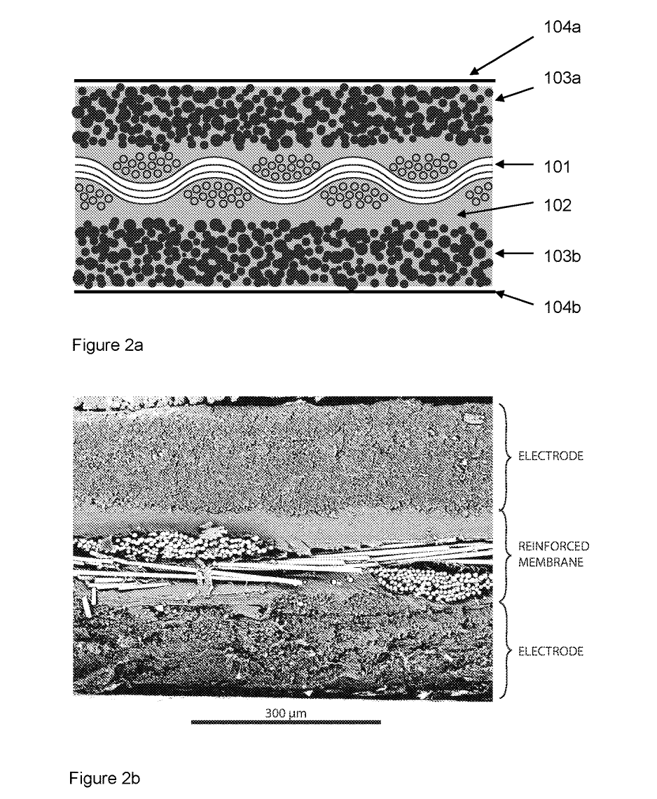

FIG. 2a shows an idealised cross sectional view of a portion of the ICL according to an embodiment of the invention. FIG. 2b is a micrograph showing an actual cross sectional view of an ICL according to an embodiment of the invention.

The web is of thickness 10-100 μm, the membrane can be entirely contained within the web, or can encapsulate the web, so that the total thickness of the electrode-separator is greater than the thickness of the web; a thickness of 120 μm for the electrode-separator would be suitable. The electrodes themselves can be up to 160 μm thick each, and the current collectors are around 1 μm thick each. The total thickness of the device is therefore around 450 μm. A thickness ratio of electrode:membrane:electrode of approximately 1:1:1 is selected, however, the membrane layer should preferably be thinner than the electrode.

Finally thicker metallic plates are bonded to each surface of the ICL at one end to provide a sound electrical contact between the power supply and the current collectors.

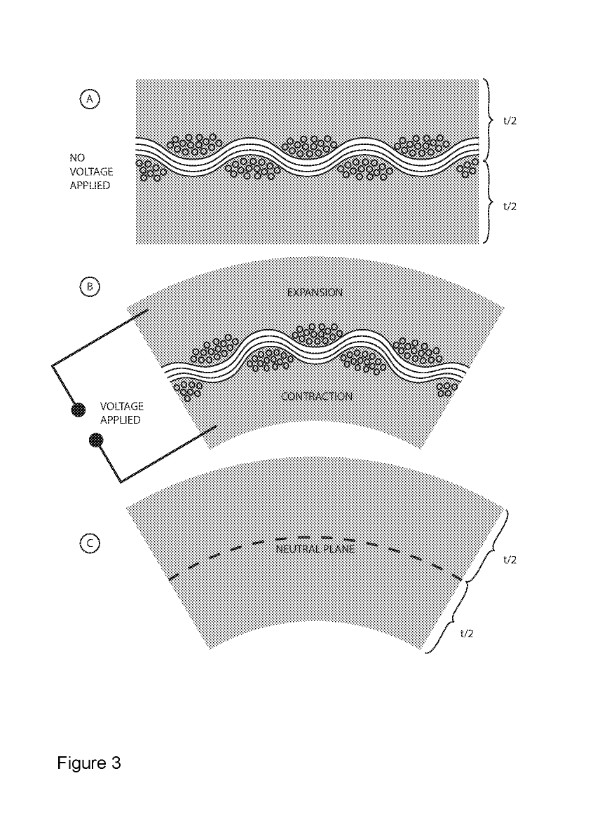

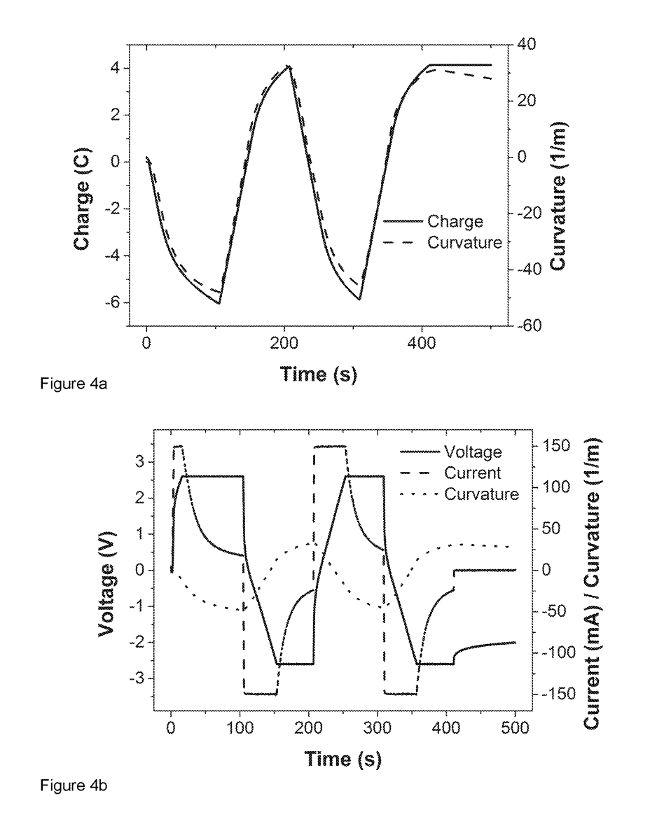

The ICL can be operated in one of three modes; i) as an actuator, ii) as a sensor/energy harvester and iii) as a capacitor. Operation in mode i) as an actuator is effected by applying a potential difference of 0.5-5 volts between the current collectors, as shown in FIGS. 1c and 3a to 3c. The electric field between the electrodes causes positive ions in the ionic liquid to migrate towards the negative electrode, while negative ions move towards the positive electrode. The accumulation of oppositely charged ions on opposite sides of the ICL causes one side to expand and the other to contract. Reversing the polarity of the electrodes reverses the direction of motion. It can be seen from FIG. 3c that in an embodiment the reinforcing web 101 is located at an equal distance (t/2, where t is total thickness of the ICL) from both sides of the laminate along the neural plane and therefore does not undergo any expansion or contraction and simply flexes. FIG. 4a shows how the curvature of the ICL varies with applied charge. FIG. 4b shows how the voltage, current and curvature are related.

In operation as a movement sensor/energy harvester, mode ii), the ICL is mounted on a surface that will undergo distortion and the electrodes connected to voltage measurement or current collection circuitry. When the surface is distorted the ICL flexes so that one electrode is expanded and the other contracted. The ions of the ionic liquid selectively move across the membrane, squeezed out of the contracted electrode to fill the available space in the expanded electrode. This creates a charge imbalance and a corresponding electric field/current movement that can be detected/harvested.

In operation as a capacitor in mode iii), an electric field is applied across the electrodes of the ICL so that cations and anions in the ionic liquid migrate towards opposite electrodes, thus storing electrical energy until the electric field is removed. The ICL need not flex in this mode.

The fabrication process of the ICL involves the following steps:

Step 1

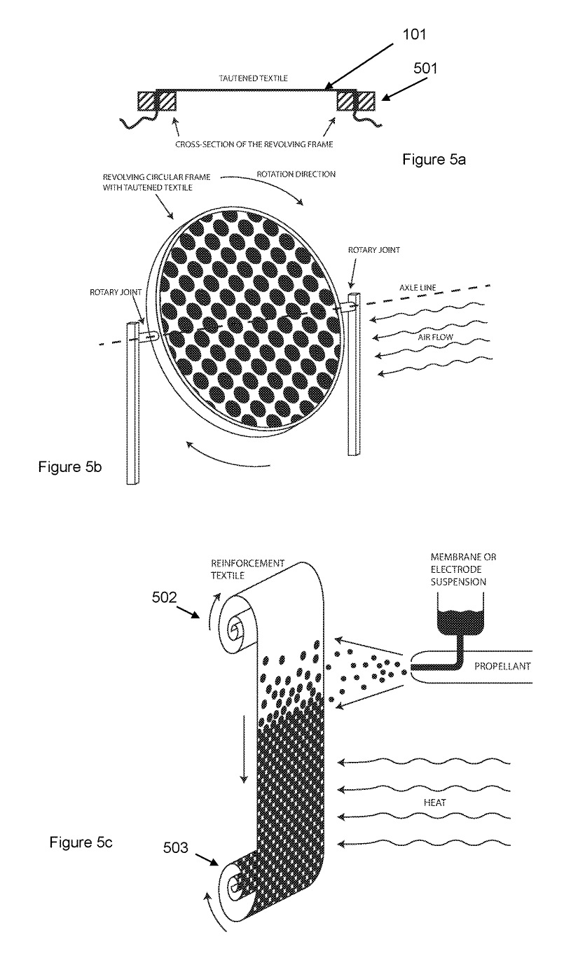

Mounting of the thin, inelastic, and electrically nonconductive reinforcing web 101 in an appropriate support. For small batches this could be in a circular frame 501 as shown in FIGS. 5a and 5b, where the reinforcing web 101 is tautened from all of its edges to the support frame 501. For larger batches the reinforcing web 101 can be supplied in rolls and wound from a feed roll 502 to a take-up roll 503, as shown in FIG. 5c. Tension is provided between the feed roll 502 and take-up roll 503 to keep the fabric taught.

Step 2

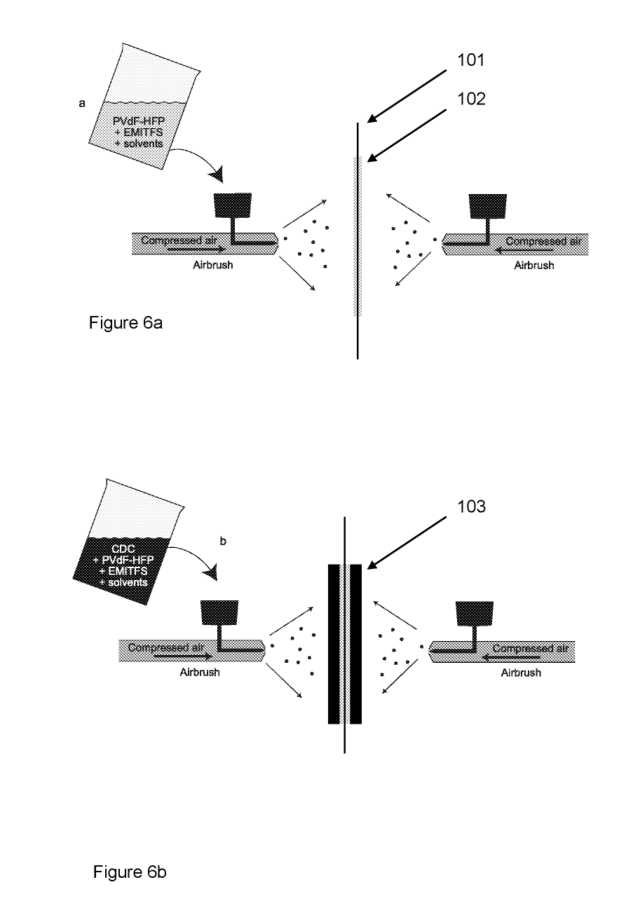

The membrane 102 is applied to the reinforcing web 101 as a mixture of an ionic liquid electrolyte and a polymer, dissolved in an appropriate volatile solvent, and is applied on the tautened reinforcement web 101 using a spray-painting technique, as shown in FIG. 5c and FIG. 6a. It is possible to also coat/impregnate the reinforcing web 101 with the membrane by other coating techniques, for example by brush, or by dip coating. The ionic liquid is 1-ethyl-3-methylimidazolium trifluoromethanesulfonate (EMITFS) (>99.0%, available from Fluka), the polymer is PVdF-HFP (available from Sigma Aldrich) mixed in a mass ratio of 50:50%. The electrolyte and polymer are mixed with solvents, 4-methyl-2-pentanone (MP, from Sigma Aldrich) and propylene carbonate (PC, from Sigma Aldrich) in a mass ratio of membrane to solvents of roughly 20:80%. The very first layer that is applied on the reinforcement grid forms a liquid film between the threads; therefore the spacing of the reinforcement grid must be selected small enough to facilitate film formation. The grid spacing is related to the viscosity of the membrane mixture (ionic liquid, polymer and solvent complex). The volatile solvents are subsequently evaporated to leave the membrane, which is an ionic gel of polymer and ionic liquid electrolyte, intrinsically bound within the pores of the reinforcing web 101. Evaporation of the solvents is by exposure to warm air (approximately 100 deg C) and if the reinforcing web 101 is retained in a clamp 501 as shown in FIG. 5b, evaporation can be enhanced by rotating the clamp. Application of the membrane 102 to the reinforcing web 101 is performed on both sides of the reinforcing web 101. Step 2 is repeated until the membrane of desired thickness is achieved. Each applied layer increases the thickness of the laminate by up to 10 μm. Generally it is not possible to apply thicker layers in one cycle. If it is applied on both sides of the reinforcing web 101 in one step (i.e. applied to both sides and then dried), then a single application step yields a 20 μm increase in thickness. The coating step is repeated until the desired thickness is reached, according to the relationship Thickness=20×number of coating/drying cycles for double sided coating. Consecutive layers are applied on the opposite sides of the membrane, so that the reinforcement grid is situated at the center of the finished membrane.

Step 3

Next the electrodes are applied to the electrode-separating layer (where the electrode-separating layer is the reinforcing web 101 supporting an ionic gel of the polymer and ionic liquid). A suspension of fine particles of the electrode active material in a mixture containing an ionic liquid electrolyte and a binder polymer that is dissolved in a volatile solvent is spray-painted on both sides of the previously prepared membrane layer, as shown in FIG. 6b.

As an example in an embodiment of the present invention, 25% (by weight) of PVdF(HFP), 50% (by weight) of EMITFS and 25% (by weight) of carbon material is dissolved in N,N-dimethylacetamide (DMAc, from Fluka). In order to form electrodes, 1 g of the polymer PVdF(HFP) was weighed and dissolved in 15 ml of DMAc. Amounts of carbide-derived carbon and ionic liquid (EMITFS) corresponding to the amount of polymer were weighed, 5 ml of DMAc was added and the mixture was stirred with an ultrasonic probe for 10 minutes. After that, the previously prepared polymer solution was added to the suspension of CDC carbon and ionic liquid. The resulting mixture was sonicated again for 20 minutes. The volatile solvents are subsequently evaporated by placing the laminate in a flow of warm air. Step 3 is repeated until the desired electrode thickness is achieved. One spray-applied layer yields approximately 10-μm increase in the electrode thickness. Due to the tautened reinforcement layer, the swelling of the laminate because of each consequently applied electrode layer does not cause the laminate to crease; instead, the laminate remains perfectly straight during the whole process. This, in turn, yields a laminate with homogenous thickness.

Step 4.

The laminate is held at <5 mbar vacuum for at least 24 h to remove the volatile solvents. The reinforcement grid is unfastened from its supports if made in small batches on the frame 501 shown in FIGS. 5a and 5b. Alternatively, if the laminate has been produced using the roll-to-roll technique shown in FIG. 5c the laminate roll is removed and the ICL cut into usable lengths. Typical dimensions are strips of length 5 cm and width 1 cm but any size is possible according to its intended use.

Step 5

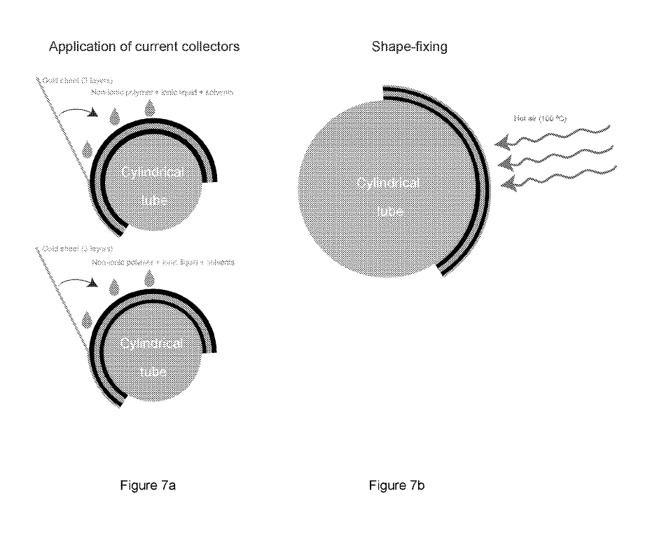

Current collectors are glued on the ICL strip. Three layers of 130 nm gold foil (from Gold-Hammer) are applied to the surface of each electrode 103, using 15 wt % Nafion solution in ethanol and water (Liquion LQ-1115 1100EW, Ion Power Inc.) or membrane solution as an adhesive. It may be desirable to produce curved ICL actuators because this can extend their range of flex. To obtain a curved ICL, the laminate prior to applying the current collectors is fixed on the outer surface of a cylindrical tube as shown in FIG. 7. Layers of gold foil are adhered to the outer electrode. The laminate is removed and re-attached to the tube, pre-buckling the existing gold foil. Further layers of gold foil are adhered to the opposite electrode. The ICL is then transferred to a larger forming tube and heated to just below the melting point of the polymer (approximately 100 deg C).

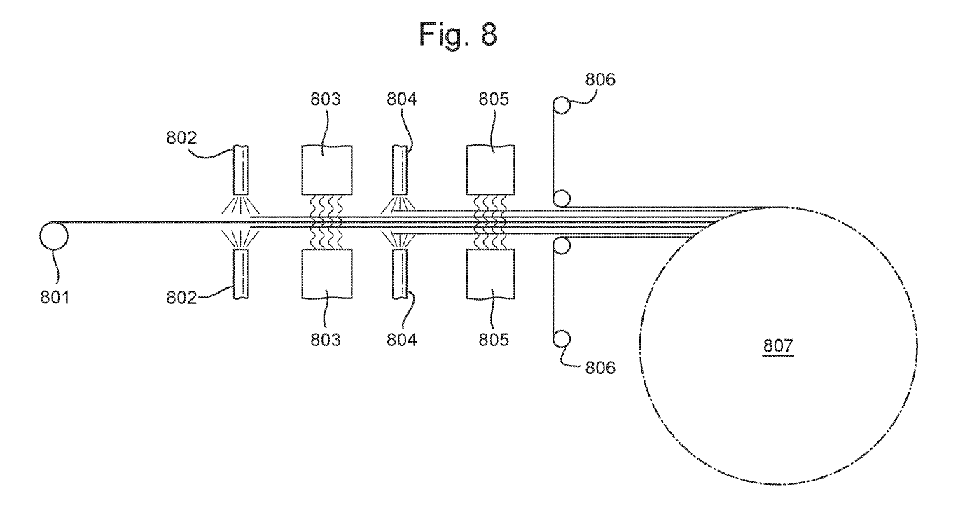

These steps can be combined into a full-scale industrial process, as shown in FIG. 8. Reinforcing web 101 is stored on roll 801, and fed through the process to take-up roll 807. The membrane is applied at stage 802 by spraying, cured at stage 803 with warm air, the electrodes applied at stage 804 by spraying and the electrodes cured at stage 805 by warm air. Current collectors are stored on rolls and applied to each surface of the laminate at 806 and the complete ICL cured, de-gassed, solvent evaporated etc at stage 807.

In the method described above, the membrane and electrodes are a gel of polymer and ionic liquid. The ionic liquid present in the gel forces the polymer to become porous and therefore provide a network permeated by the ionic liquid. Volatile solvents added to the polymer solution or electrode suspension before spraying also facilitate formation of porous structure, and the porous structure is preserved after evaporation of the volatile solvents.

However, the ionic liquid could be omitted during fabrication. Another liquid can be used in its place during fabrication of the electrodes and membrane so that the polymer forms a porous structure around the liquid; the ionic liquid can later be substituted for the first liquid.

The ability to spray-paint both the membrane and the electrode layers is derived form the use of the reinforcing web 101. Spray-painting of the membrane results in a membrane that has a more desirable microstructure, which is expressed in an increased ionic conductivity. Irrespective of how a membrane is manufactured (casting, rolling, spray-painting), the subsequent spray-application of the electrodes results in extensive swelling of the membrane. Ordinarily, swelling causes dimensional changes, which is expressed in extensive creasing of the membrane. Softening and creasing of the membrane results in an uneven coat or a torn-apart membrane, especially in the case of larger samples. The use of the supporting reinforcement grid as the middlemost layer allows the entire structure to be supported as the membrane swells and therefore prevent creasing or breakage of the membrane. Spray painting of membrane and electrodes removes the need to hot press the ICL and therefore considerably reduces the possibility of introducing hotspots due to short circuits during the fabrication process. Spray painting of all of the elements of the ICL, including the membrane also has the advantage that ICLs can be applied to different textiles and meshes, which can be constituents of larger systems such as clothes, curtains and air filters for example. Using spraying, it is possible to make ICLs having complex shapes by patterning in a way that is not possible if the membrane has to be cast.

It is possible to use ionic polymers as a membrane material, such a Nafion. However, it is much more difficult to spray this type of material. The resulting layers are inhomogeneous and this imposes more constraints on the fabrication process. The constraints are both economical and technical. Nafion, and also other available ionic polymers are trademarked and expensive. Ionic polymers offer interest for niche markets such as fuel cells, where they are functionally irreplaceable. Large-scale fabrication of ICLs (for example manufacturing of smart textile that incorporates ICLs) based on Nafion is unlikely, as cheaper alternative materials are widely available. Spraying of Nafion-ionic liquid membrane is not possible, as it does not form a uniform membrane layer. Preparation of homogeneous ionic polymer-based membranes can be done by casting pure ionic polymer and subsequent swelling in an electrolyte, e.g. in ionic liquid. The use of ionic polymers can require extra steps to be introduced to the manufacturing process.

The ICLs with a supportive grid can be readily integrated into almost any kind of textile. Functional textile can be fabricated by patterning the ICL applied to the textile, so that some parts of the textile, where the membrane and electrode layers have been applied, have electroactive properties. The textile itself is not damaged, it can still perform as a load-bearing member. The membrane and electrodes can be inkjet printed, silkscreen printed or stencilled onto a fabric to produce patterned ICLs. Applications include smart garments where the functional actuators, sensors and capacitors can be applied directly to fabric of the garment.

Non-woven reinforcing web material is also suitable provided it has the necessary permeability, such as felt or paper. However, this tends to be thicker and less strong than woven fabric.

In preparing a composite sensor/actuator according to the present invention, the carbide-derived carbons (SiC-CDC, TiC-CDC, Mo2C-CDC, Al4C3-CDC, B4C-CDC, VC-CDC, NbC-CDC, etc.) may be used as carbonaceous material, but carbon aerogels are also suitable. CDCs are less suitable for any industrial application because of their high cost. Instead, porous activated carbons made by pyrolysis or hydrothermal carbonization of organic matter provide comparable results, but these carbons are orders of magnitudes cheaper, as their precursors are extremely abundant. With the aim to improve electron-conductive properties, both sides of a composite may be coated with a thin metal layer. As additional carbonaceous material, single-wall carbon nanotubes of high purity and metallic conductivity may be used as well as commercially available TIMCAL SUPER R carbonaceous material. Suitable polymers are selected according to their solubility in the selected solvent, their chemical stability in a given system and the mechanical properties of a polymer, also the porosity of the polymer-based membrane. In an embodiment of the present invention, PVdF(HFP), a polymer belonging to a large family of fluoropolymers was used, but another member of the same family, KYNAR 2801, has also been tested. For use as a membrane only, cellulose-based polymers (e.g. products by NIPPON KODOSHI 5) may be used. Suitable ionic liquids are the liquids that are capable of remaining liquid at the operating temperature of the sensor and in a given composite sensor/actuator system. In preferred applications of the present invention, ionic liquids are of low viscosity (less than 1 Pa), have a low melting point and high ionic conductivity.

Ionic liquids as the electrolyte do not evaporate. In a timescale of at least 100 years, in atmospheric conditions, the evaporation is negligible. What is more, ionic liquids do not evaporate even in high vacuum, and the ICLs fully retain their operating ability while exposed to high vacuum conditions (<1 mbar) even at elevated temperatures (100 ° C.). Thus, ICLs made with ionic liquids are also operable for use in space conditions. Therefore it is not necessary to seal the ICL.

However, it is beneficial to seal the ICL for the following reasons:
a) To prevent contamination of the ionic liquid with any other substances, which can lead to deterioration of the ICL. Contaminants include water (completely without water content, the operating voltage of an ICL would be considerably higher, as its electrochemical window is higher), or other salts, or other impurities.
b) To prevent leakage of ionic liquid into human bodies, if the ICL is used in wearable applications, smart textiles, etc.
c) To prevent “wash-out” of the ionic liquid, if the ICL is operated in water or is in contact with flowing, dripping, or condensing water.

As discussed above it is possible to manufacture the ICL without an ionic liquid, using a non-ionic liquid initially to assist in the formation of the correct structure of the membrane (a polymer infiltrated with a continuous network of channels). The end user can then functionalise the ICL by substituting the non-ionic liquid with an ionic liquid to provide the medium by which ions are conducted between the electrodes.

1. An ionic electroactive polymer laminate suitable for use as an actuator, comprising
opposing planar electrodes separated by an electrode-separating layer, wherein the electrode separating layer comprises a flexible porous reinforcing web suitable for supporting the laminate during fabrication, the electrode-separating layer further including an ion permeable polymer membrane in the free space within the reinforcing web.

2. An ionic electroactive polymer laminate in accordance with claim 1, wherein the membrane encapsulates the reinforcing web.

3. An ionic electroactive polymer laminate in accordance with claim 1, wherein the electrodes are a porous flexible material comprising a mixture of polymer and a conductive material.

4. An ionic electroactive polymer laminate in accordance with claim 3, wherein the conductive material is carbon-based.

5. An ionic electroactive polymer laminate in accordance with claim 1, wherein the membrane and the electrodes contain the same type of polymer.

6. An ionic electroactive polymer laminate in accordance with claim 1, wherein the membrane and electrodes are impregnated with an ionic liquid as an electrolyte.

7. An ionic electroactive polymer laminate in accordance with claim 1, wherein the reinforcing web is a textile.

8. An ionic electroactive polymer laminate in accordance with claim 7, wherein the textile is 10-100 microns thick.

9. An ionic electroactive polymer laminate in accordance with claim 1, wherein the web is of a non-woven material.

10. An ionic electroactive polymer laminate in accordance with claim 1, wherein each of the planar electrodes has an inner face in contact with the electrode-separator and an outer face, wherein a metallic current collecting foil can be provided in contact with the outer face of each of the electrodes.

11. An electrode-separator for use in an ionic electroactive polymer laminate, comprising a flexible porous reinforcing web suitable for supporting the laminate during fabrication, the electrode-separating layer further including an ion-permeable polymer membrane located within the pores of the reinforcing web.

12. An electrode separator in accordance with claim 11, wherein the membrane is impregnated with an ionic liquid as an electrolyte.

13. The use of an ionic electroactive polymer laminate of the type defined in claim 1 as an actuator, a sensor or an energy storage device.

14. (canceled)

15. (canceled)

16. A method of producing an ionic electroactive polymer laminate suitable for use as an actuator, comprising the steps of producing a planar electrode-separator by supporting a flexible, porous reinforcing web so that it is taught, impregnating the reinforcing web with a membrane solution, wherein the membrane solution includes a polymer suitable for forming an ion permeable membrane, a pore-forming liquid for forming pores in the polymer and a solvent, the method further including the steps of evaporating the solvent to form an ion permeable membrane within the structure of the reinforcing web, the method further including the steps of coating each side of the planar electrode-separator with an electrode solution comprising material suitable for forming electrodes and an electrode solvent, evaporating the electrode solvent to form planar electrodes separated by the electrode-separator.

17. A method of producing an ionic electroactive polymer laminate in accordance with claim 16, wherein the membrane solution and/or the electrode solution is applied by spraying, painting or dip coating.

18. (canceled)

19. (canceled)

20. A method of producing an ionic electroactive polymer laminate in accordance with claim 16, wherein the cycle of applying the membrane solution and evaporating the solvent is repeated to produce a membrane of a required thickness.

21. A method of producing an ionic electroactive polymer laminate in accordance with claim 16, wherein the cycle of applying the electrode solution and evaporating the solvent is repeated to produce electrodes of a required thickness.

22. A method of producing an ionic electroactive polymer laminate in accordance with claim 16, wherein the pore-forming liquid is an ionic liquid.

23. A method of producing an ionic electroactive polymer laminate in accordance with claim 16, wherein the electrode material is a mixture of a polymer, an electrically conductive material and a pore-forming liquid for forming pores in the polymer.

24. A method of producing an ionic electroactive polymer laminate in accordance with claim 16, wherein the pore-forming liquid is an ionic liquid.

25. A method of producing an ionic electroactive polymer laminate in accordance with claim 16, wherein the pore-forming liquid is a non-ionic liquid and including the additional step of replacing the non-ionic liquid.

26. A method of producing an ionic electroactive polymer laminate in accordance with any claim 16, wherein the conductor is carbon based.

27. A method of producing an ionic electroactive polymer laminate in accordance with claim 16, further including the steps of applying metallic foils to the outside of the electrodes as current conductors.

28. A method of producing an ionic electroactive polymer laminate in accordance with claim 16, where the laminate is applied in a pattern by a method selected from the list of screen printing, stencilling or inkjet printing.
